(19) United States
(12) Patent Application Publication
(10) Pub. No.: US 2003/0103079 A1
(43) Pub. Date: Jun. 5, 2003

(54) Media resource manager/player

(75) Inventors: Al-Riaz Adatia, Sunnyvale, CA (US); Ian Lyman, San Francisco, CA (US); Andrew McCann, San Francisco, CA (US); Tony Million, San Francisco, CA (US); Nicholas Vinen, San Francisco, CA (US)

Correspondence Address: FISH & RICHARDSON PC, 225 FRANKLIN ST, BOSTON, MA, 02110, US

(73) Assignee: Lycos, Inc., a Virginia corporation

(21) Appl. No.: 10/339,028

(22) Filed: Jan. 9, 2003

Related U.S. Application Data
(62) Division of application No. 09/593,877, filed on Jun. 14, 2000.
(60) Provisional application No. 60/139,158, filed on Jun. 14, 1999.

(51) Int. Cl. G09G 5/00

(52) U.S. Cl. 345/762

(57) ABSTRACT

A number of user interface techniques for virtual instruments implemented using a computer are disclosed. These techniques include providing a multi-sized user interface, separating a user interface into two control regions, providing a pop-out control panel, providing a graphical playlist indicator, inter-relating band controls, controlling button illumination, sliding information onto and off of a display panel, integrating visualizations into an instrument, and providing a pop-out control panel with control buttons.

### CROSS REFERENCE TO RELATED APPLICATIONS

Priority is claimed to U.S. Provisional Application No. 60/139,158, filed Jun. 14, 1999, which is incorporated herein by reference.

### BACKGROUND OF THE INVENTION

The field of the present invention relates to user interface controls for virtual instruments displayed using a computer, and to the application of user interface controls in the context of a media player (e.g., an audio player).

Virtual instruments have been implemented on computers for some time. However, the user interfaces for many of these virtual instruments are often inconsistent with the instruments that they are intended to portray. The inventors have recognized a need for improvements to the user interfaces of virtual instruments.

### SUMMARY OF THE INVENTION

The present invention relates to certain aspects of a user interface for a virtual instrument that is being displayed by a computer. These aspects include providing a multi-sized user interface, separating a user interface into two control regions, providing a pop-out control panel, providing a graphical playlist indicator, inter-relating band controls, controlling button illumination, sliding information onto and off of a display panel, integrating visualizations into an instrument, and providing a pop-out control panel with control buttons.

### BRIEF DESCRIPTION OF THE DRAWINGS

FIG. 1 is an example of a large-mode user interface for a media player.

FIG. 2 is an example of the large-mode user interface with a slide-out panel extended.

FIG. 3 is an example of the large-mode user interface after the visual mode icon has been clicked.

FIG. 4 shows a track progress indication in the large-mode user interface.

FIG. 5 is an example of a file information display.

FIG. 6 is an example of a full-window visualization mode display in the large mode user interface.

FIG. 7 shows an alternative full-window visualization display in the large mode user interface.

FIG. 8 shows the audio control mode in the large mode user interface.

FIG. 9 shows the audio control mode with the equalizer controls set to different positions.

FIG. 10 shows the audio control mode with spline tension turned off.

FIG. 11 shows a general menu in the large mode user interface.

FIG. 12 shows a the setup menu of FIG. 11, with an alternate skin being displayed.

FIG. 13 shows the large mode user interface after the alternate skin has been applied.

FIG. 14 shows the visual effects menu in the large mode user interface.

FIG. 15 shows a plug-ins menu in the large mode user interface.

FIG. 16 shows an information screen in the large mode user interface.

FIG. 17 shows a playlist editor screen in the large mode user interface.

FIG. 17B shows a music download screen in the large mode user interface.

FIG. 18 shows a medium size user interface for a media player.

FIG. 19 shows the medium size interface with a different visualization waveform selected.

FIG. 20 shows a small mode user interface for a media player with the control tray retracted.

FIG. 21 shows the small mode user interface with the control tray extended downward.

FIG. 22 shows the small mode user interface with the control tray extended upwards.

### DETAILED DESCRIPTION OF THE PREFERRED EMBODIMENTS

The preferred embodiment of the present invention is an audio player and file managing system. It runs as an application on a computer running an operating system such as Windows or Linux. The preferred audio player can appear in any of three display modes: small, medium, and large.

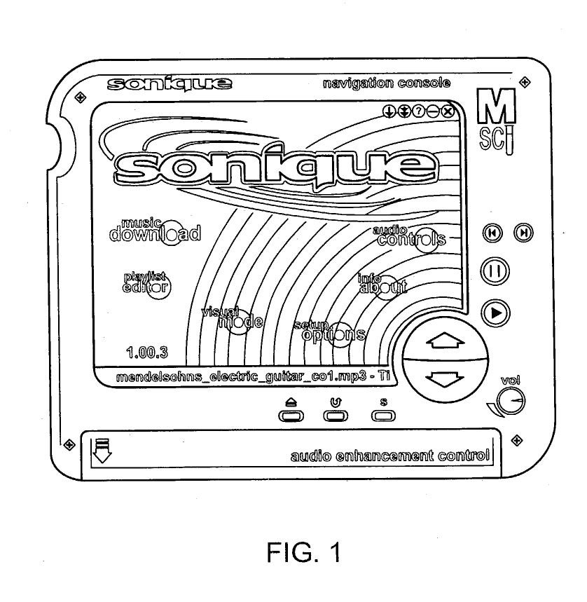

The large mode, also referred to herein as the navigation console, is shown in FIG. 1. It includes two different types of controls: a group of “hardware like” controls that includes buttons and knobs, and a group of display-based controls.

The hardware-like controls are operated by the user by clicking on them with a mouse and manipulating them. For example, the play button appears as a round green button with a triangle icon over it. When the mouse pointer is placed over this object, and the left mouse button is pressed, the player will begin to play the currently selected song. Similarly, when the mouse is placed over the pause button and the mouse button is clicked, the currently playing song will be paused. Pressing the pause button again will resume the playing of the song. These controls are called “hardware-like” because their operation mimics the operation of physical pushbuttons on a physical piece of audio equipment like a CD player or a cassette deck.

The hardware-like section also includes a volume control knob, which is operated using the mouse, as explained in section 2 of the appendix. It also contains track forward and back buttons, a repeat button, a shuffle mode button, and a file select button. The hardware section also includes up and down buttons for toggling between various options, which will be described below.

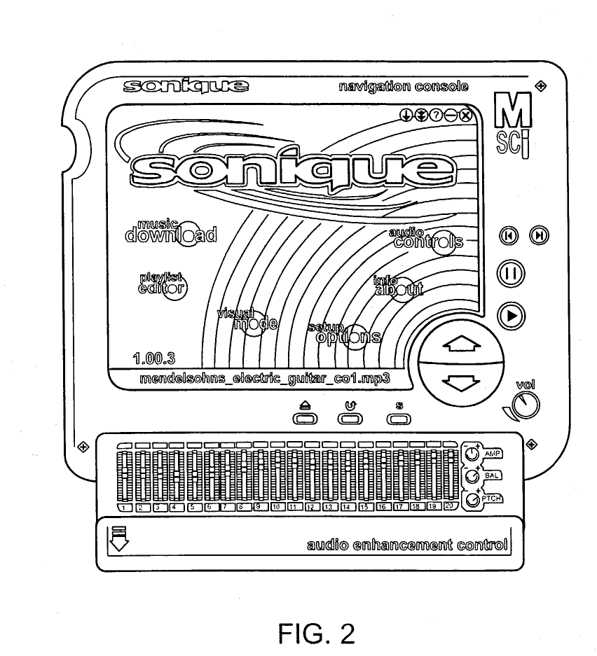

The hardware-like section also includes a slide-out panel, which pops out by clicking on the arrow icon (at the bottom left of FIG. 1) with a mouse. When the user pops this panel out, it reveals an additional set of hardware-like controls, as shown in FIG. 2. These controls are explained in section 10 of the appendix. The equalization settings of the player can be modified by clicking and dragging the equalization sliders up or down. The balance, amp, and pitch control knobs in the slide out panel operate in a similar manner as the volume control knob. The slide-out panel can be closed (and returned to the configuration of FIG. 1) by clicking on the arrow icon.

In addition to the hardware-like control described above, the player also includes computer-like display based controls. These include a set of navigation buttons which appear as small circles in the upper right corner of the display area of the player. These navigation controls are described in section 2 of the appendix. At the very bottom of the display area is the title of the currently selected song. Immediately above the selected song, to the left, is the version of the software running on the player. The central region of the display includes six selection objects: music download, playlist editor, visual mode, setup options, info about, and audio controls. The user can access any of these modes by clicking on the corresponding region of the display. The display regions shown in FIGS. 1 and 2 is called the console navigation screen, which and is also referred to as the main menu.

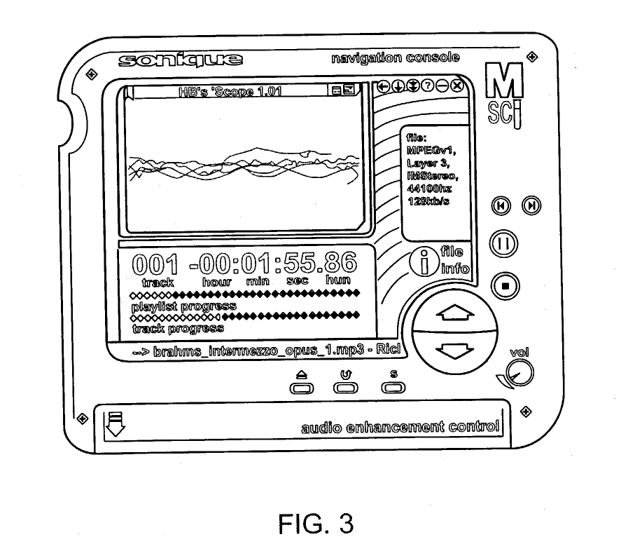

FIG. 3 shows the state of the display after when the visual mode icon has been clicked. The hardware-like controls at the right side and the bottom of the player do not change—they remain the same throughout all the modes. The navigation buttons in the top right of the display appear in this mode as well, as with the other modes. In the top left corner of the display is a visualization window. This window displays a moving graphic that is preferably related to the music being played.

A track and time indicator is a digital readout located immediately beneath the visualization window. The track indicator indicates which track is being played. The time indicator indicates the amount of time that has elapsed in the track that is currently being played. If the mouse is clicked over the time indicator, it switches to display the amount of time remaining (i.e. unplayed) in the current track.

The playlist progress indicator and a track progress (time) indicator are located beneath the digital readout. The playlist progress indicator is a linear display of the progress through the playlist, and the track progress indicator is a linear display of the progress through the track. At the beginning of a track, the track progress indicator is dark. As the song plays, the left side of the track progress indicator will light up. The illuminated portion on the left side will grow towards the right as the song progresses, until it reaches the right end of the track progress indicator at the end of the song.

In addition to their display function, the user can use these progress indicators to jump to any portion in the song by clicking the mouse over the corresponding spot on the track progress indicator. For example, if the user wants to jump directly to the exact center of the song, he would click on the center of the track progress indicator. If the user wants to return to the beginning of the song, he would click on the left side of the track progress indicator. The playlist progress indicator operates in a similar manner, except that the different portions of the playlist indicator correspond to the different tracks of the playlist. Thus, in the displayed example, where the playlist includes exactly two songs, the left half of the playlist progress indicator corresponds to the first song (the first track) and the right half of the playlist progress indicator corresponds to the second track. The user can jump directly to the first track by clicking on the left half of the playlist progress indicator, and can jump to the second track by clicking on the right half of the playlist progress indicator. In cases where there are N tracks on the playlist, the playlist progress indicator would be divided into N equally spaced control regions.

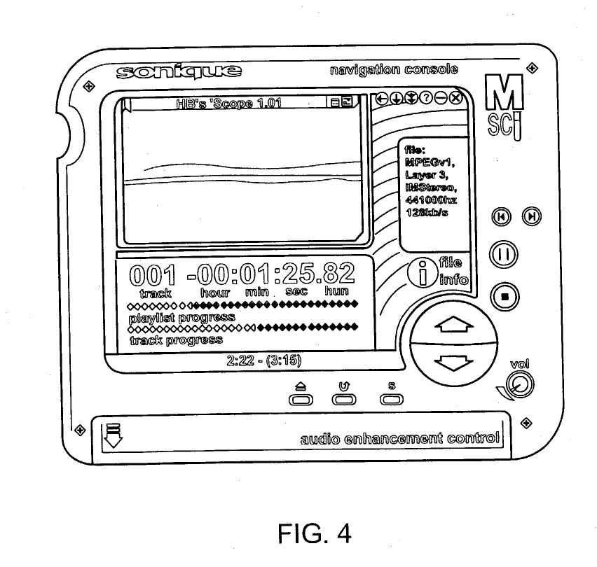

As the mouse pointer is moved over the various portions of the playlist progress indicator, the name of the corresponding track appears on the bottom portion of the display. As the mouse pointer is moved over various portions of the track progress indicator, the corresponding time and the time remaining in that track appears at the bottom of the display. This is depicted in FIGS. 3 and 4 respectively.

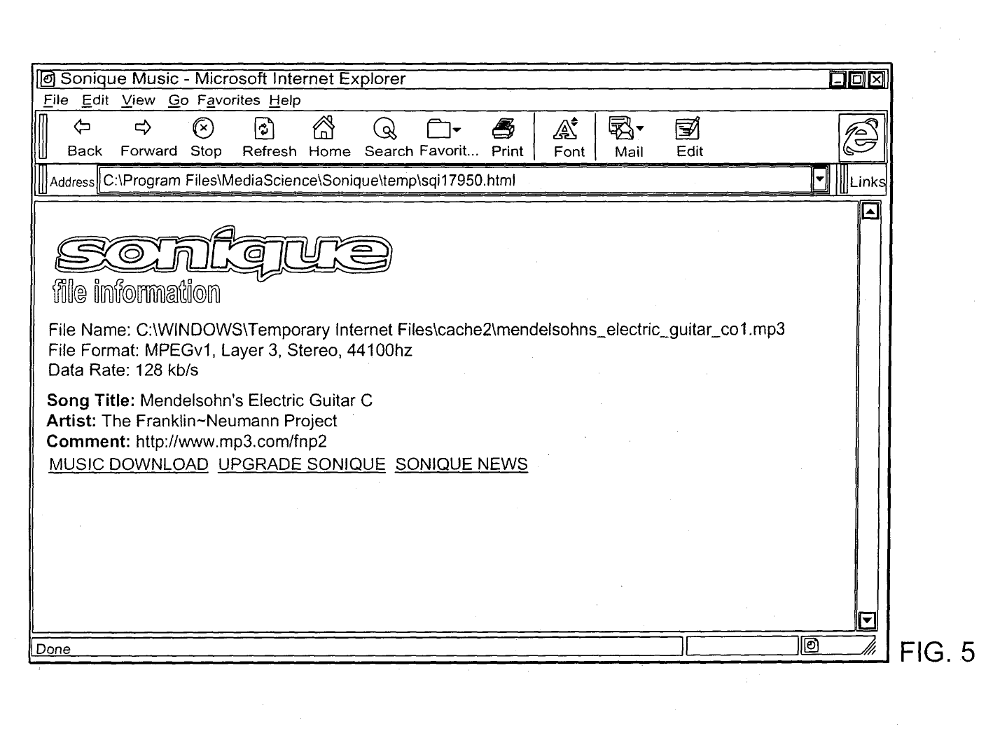

When the user clicks on the “file info” object of the main menu, the player generates an HTML page and a call is made to launch a browser to display the generated HTML page. Preferably, this HTML page will contain additional information about the track currently being played. An example is shown in FIG. 5.

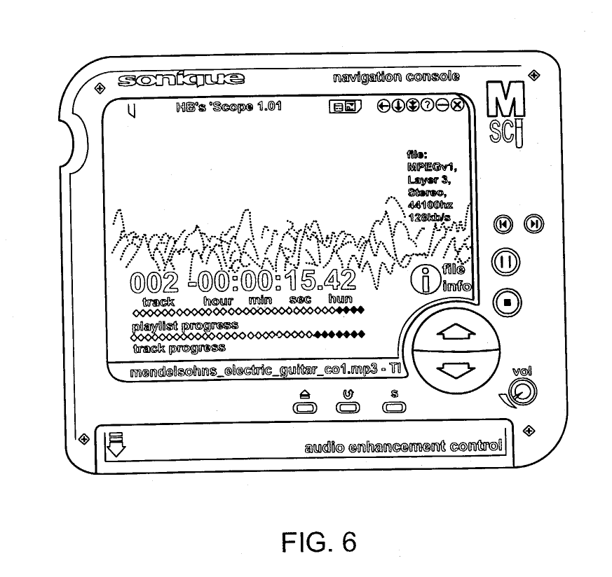

Returning to FIG. 4, in the top right corner of the visualization area there are two small icons. When the rightmost of these icons is clicked, the display will switch to full-screen mode and fill the entire computer monitor. This is called the full screen VIS mode. When the leftmost icon is clicked, the display changes into the full window VIS mode. FIG. 6 is an example of the display in the full window VIS mode. When in this mode, the display can be returned to the normal VIS mode (as shown in FIG. 4) by clicking the left icon.

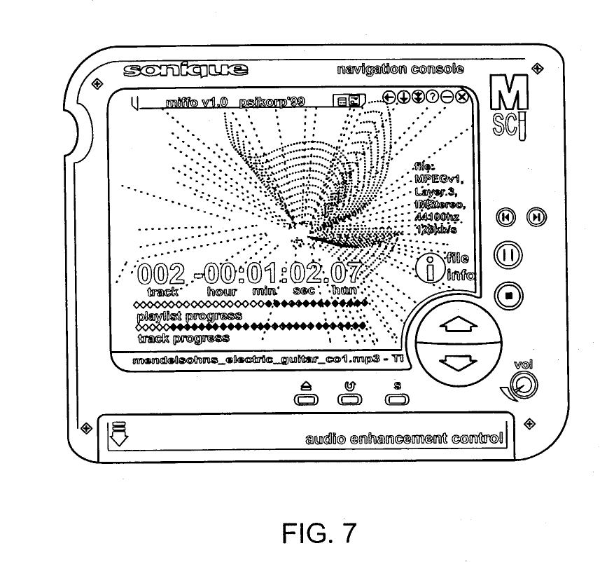

The controls operate the same way in full window VIS mode and normal VIS mode. Controls are not, however, available in the full screen VIS mode. To regain control of the player in the full screen VIS mode, the user presses the escape button on the computer. In both the full window and the normal VIS mode, the up/down button toggles between the different display visualization options. FIG. 7 shows an alternative visualization display which was selected by clicking on the up button. The various visual displays are sequenced through by pressing the up and down buttons.

To return from the visual mode to the main menu, the user presses the right mouse button. An alternative way of returning to the main menu is to click on the left facing arrow and the small navigation button located at the top right of the display.

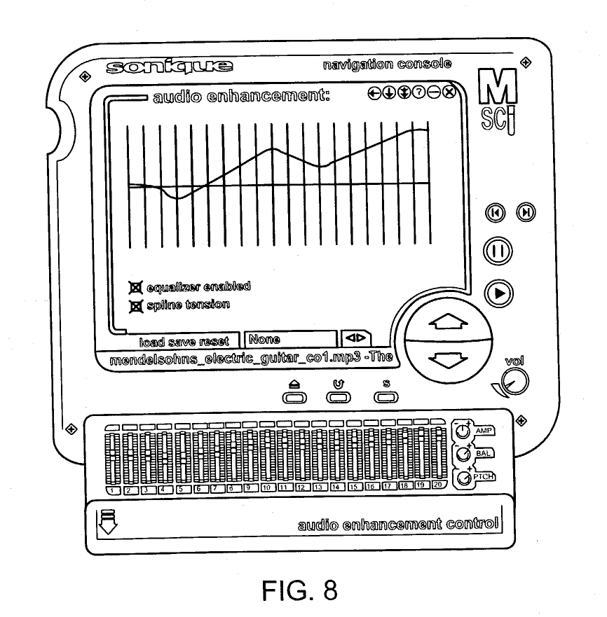

FIG. 8 shows the display after the user has clicked on the “audio controls” object of the main menu. The visual mode has been turned off in this figure for clarity, although it could remain on if the user so desires. In the audio control mode, the audio enhancement control panel is automatically opened, and an equalization graph is displayed above it. In this mode, the user can modify the frequency response of the player by sliding the equalization sliders (located in the sliding control panel) up or down.

The display region also includes two boxes: equalizer enabled and spline tension. When the user clicks his mouse pointer in one of these boxes, an X is alternately placed or cleared in the box. By X-ing the equalizer enabled box, the user instructs the system to apply the equalizer settings to the audio being generated. When the equalizer enabled box is not Xed, the equalizer settings are not applied. Near the bottom of the display are load, safe, and reset icons, which are explained in section 10 of the appendix. When the user clicks on reset icon, the equalization settings all return to their center position.

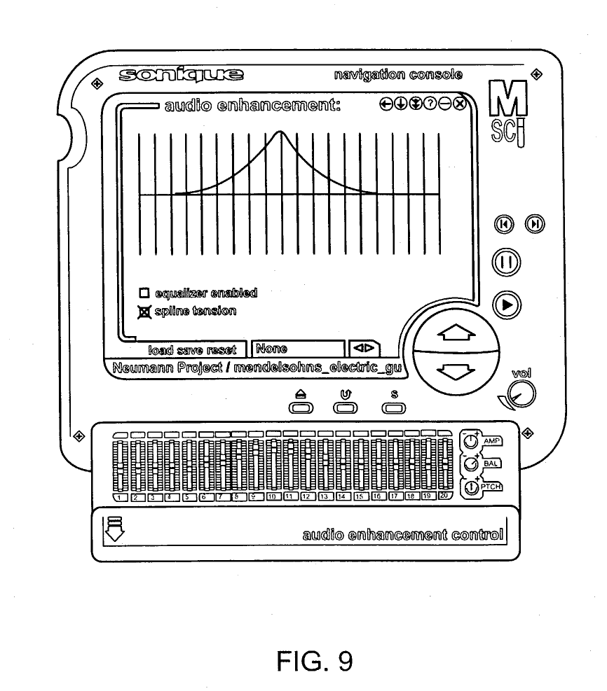

When spline tension is turned on, sliding one of the equalizer controls effects its neighbors with a rubber-band-like effect. Thus, after resetting the equalizer settings by clicking on reset, if only the center equalizer knob number 10 is moved to the top, the result will be as shown in FIG. 9. Preferably, this effect is inversely proportional to the square of the distance between the sliders.

In the preferred implementation, when the user first clicks on any slider, the state of all the sliders are saved. Then, when the selected slider is moved, a difference for each of the sliders is computed and then applied to the original saved state of the other sliders. The saved state, however, is not updated until the slider that is currently being moved is released (by releasing the mouse button. Because the saved state is not updated dynamically, movement of any given slider control will not initiate time-variant rippling through the other controls. This arrangement also enables a slider that is returned to its original position and released to leave the other sliders in their original positions.

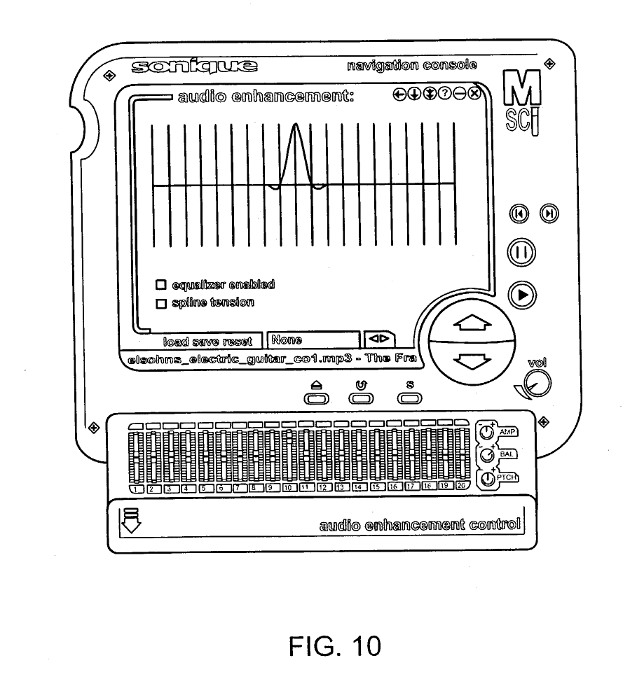

In contrast, when spline tension is turned off and the equalizer is reset, and the equalization slider number 10 is then moved up to the top, the resulting frequency response will be as shown in FIG. 10.

If the user has a particular equalization setting that he likes, he can save that setting by clicking on “save” near the bottom of the screen. A menu slides in and asks the user for a location name for saving the equalization settings. Then, at any later time, the user can return to that equalization setting by clicking on the load on the bottom left of the audio control screen and selecting the corresponding preset file. The user can also select from various predefined presets by clicking on the left and right arrows at the bottom right corner of the display. These arrows will select predefined equalization settings such as classical, jazz, rock, pop, and dance.

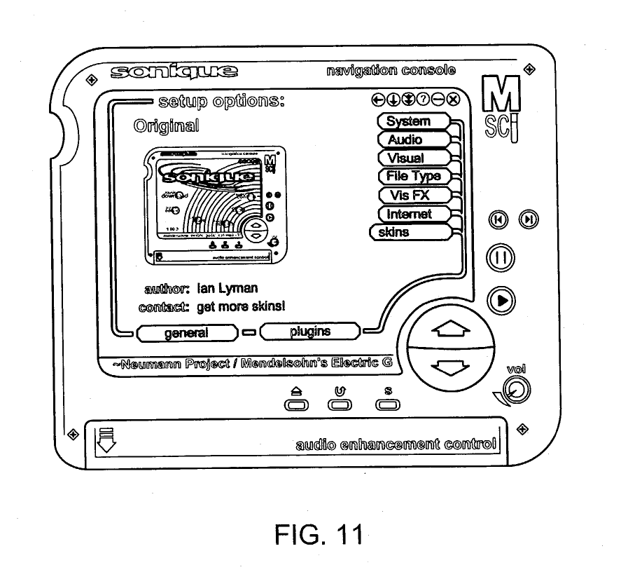

Another menu that is accessible on the main level is setup options. When the setup options object is clicked, the screen changes to the configuration shown in FIG. 11. The general and plug-ins region at the bottom of the display select between two distinct menus. The selected menus appears at the right hand side of the display. In FIG. 11, the general menu is selected. This general menu includes entries of system, audio, visual, file type, Vis FX, Internet, and skins.

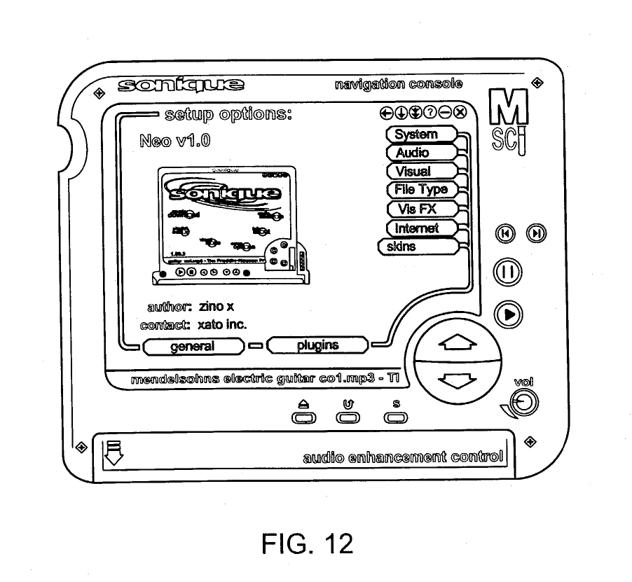

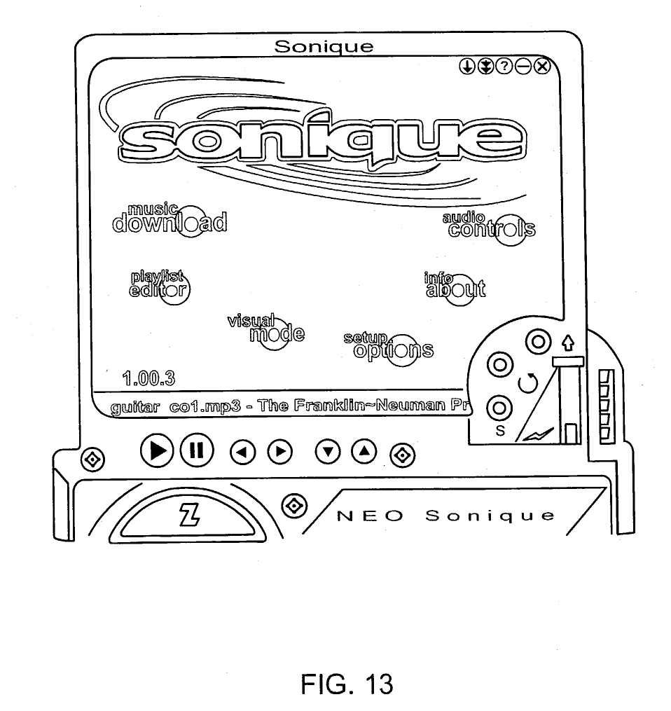

In FIG. 11, the skins selection is wider than the other menu selections because that selection is currently selected. In this mode, The user can toggle through the various available skins by clicking on the up and down select buttons. After clicking on the up select bottom, the next skin is displayed, as seen in FIG. 12. The new skin takes effect when the visual mode is exited (by either clicking on the right mouse button or on the left arrow navigation bottom). The player will then take on the appearance of the newly selected skin, as shown in FIG. 13.

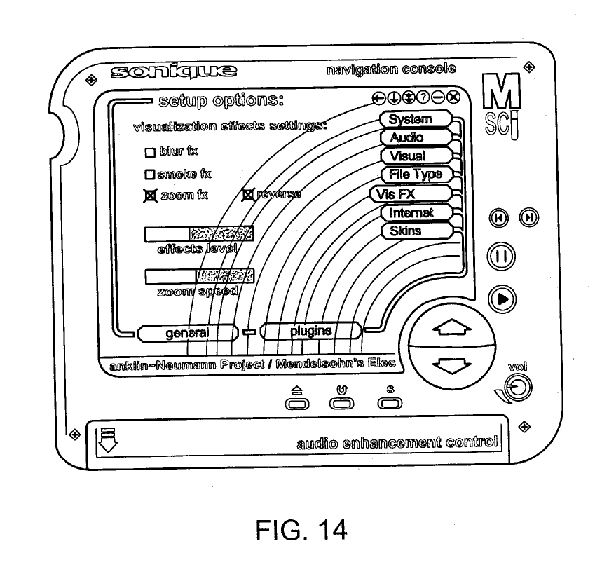

Returning now to the setup options of the originally selected display skin, other submenus can be selected by clicking on the desired region displayed on the right side of the screen. For example, when the Vis FX region is clicked, the display will appear as shown in FIG. 14. Note that now the Vis FX bubble is wider than the other bubbles, because it is selected. This mode is used to add special effects to visualization that are displayed in the visual mode. These special effects include blur, smoke, and zoom. The “reverse” check box reverses the direction of the zoom from zoom in to zoom out.

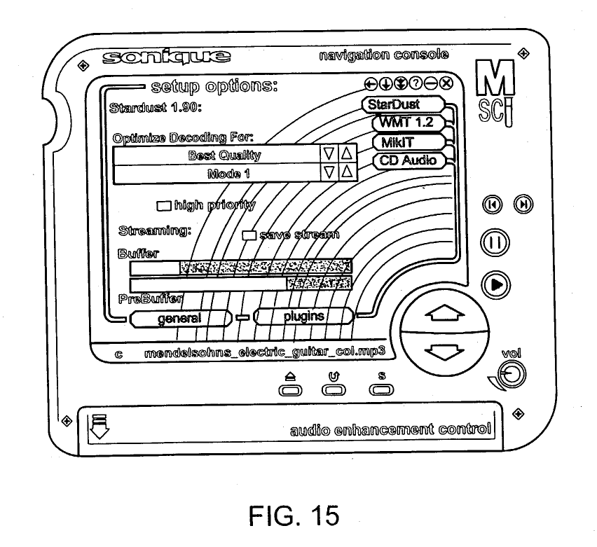

When the “plugins” region at the bottom is clicked, the menu selectors at the right side shrink towards the right. Meanwhile new menu selectors grow toward the left. In the plugins mode, these new menus include stardust, WMT 1.2, MikIT, and CD audio, as shown in FIG. 15. These setup options are discussed in section 8 of the appendix.

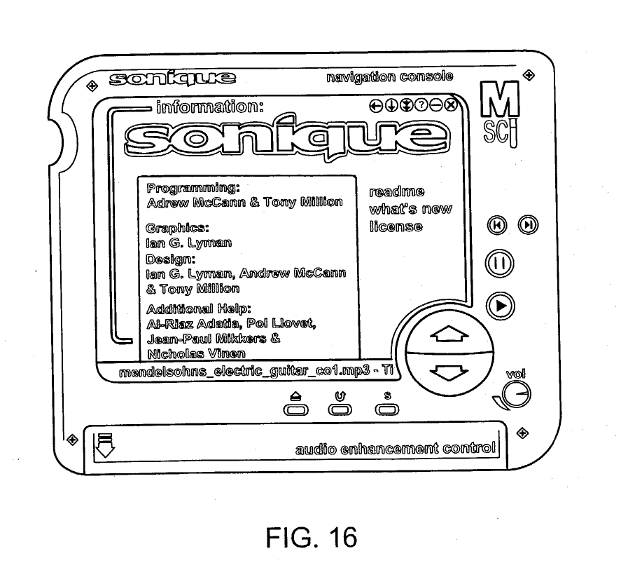

When the “info about” region on the main menu is clicked, the display shown in FIG. 16 appears. This display contains general information and also includes three mouse-selectable regions on the right: read me, what's new, and license. When the user clicks on one of these selectable regions, the system generates an HTML page and launches a browser (such as Internet explorer or Netscape navigator) in a conventional manner. The launched browser will then display canned information associated with the selected word.

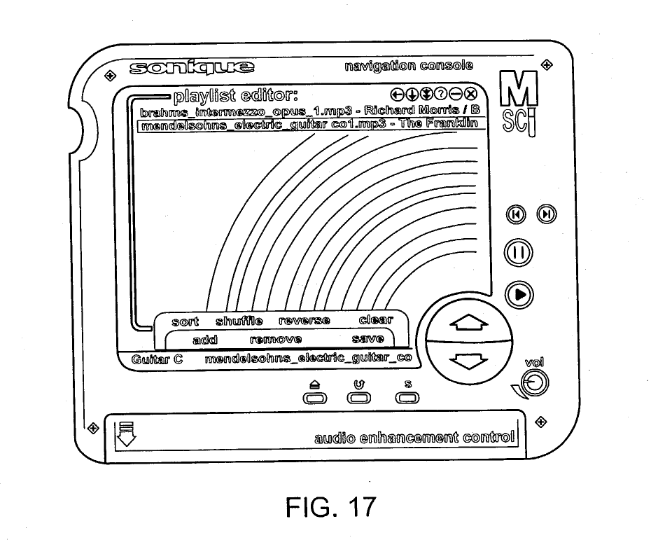

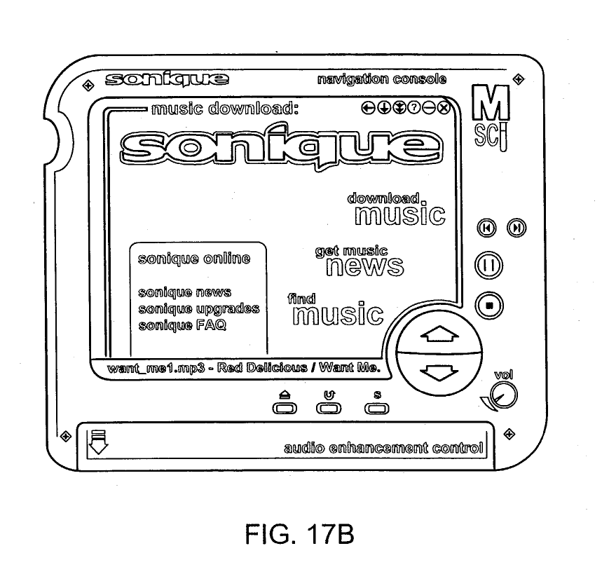

When the “playlist editor” is selected from the main menu mode, the display will change to the configuration of FIG. 17. In this mode, the unit displays all of the tracks that are currently loaded into the unit. In the example of FIG. 17, two tracks are loaded: Brahms intermezzo and Mendelsohn electric guitar. The up and down buttons are used to point to the desired track, and the play button is then used to start the play function. After being pressed, the brightness of the play button momentarily increases, which provides the user with positive feedback. Then, the green-light color of the play button slowly fades out, and it is replaced with a red-light colored stop button. Preferably, the play button has a triangle icon, stop button has a square icon, and the fade in/out takes 200 mSEC. Alternatively, the user may use a mouse and double click on the title in the play list to select and start the desired track.

At the bottom of the playlist editor screen are sort, shuffle, reverse, clear, add, remove, and save. Clicking on any of these words performs the associated function, as described in section 6 of the appendix. In particular, clicking on save opens a window on the computer screen asking for a destination file into which the playlist should be saved; and clicking on add opens a similar window for loading a previously stored playlist from the computer. Additional information is provided about each of these menu selections at the bottom of the display as the mouse pointer is moved over the corresponding selection region.

When the “music download” button from the main menu is selected, a number of menu regions will appear on the screen, as shown in FIG. 17B. These regions preferably includes links provided by the player software manufacturer. When the user clicks on one of these links, the player sends a URL to a browser and the browser obtains the associated web page. If the browser is not already running, the player will issue a call to start up the browser. The user then navigates the web in a conventional manner in order to download audio content. In the music download mode, whenever the mouse pointer is placed over one of the links, an explanatory message is displayed at the very bottom of the display.

In general, when one menu is being replaced with another, the transitions are not abrupt. So instead of abruptly disappearing, an old menu will slide off to the side, to the bottom, or into a corner. Then, the replacement menu will slide in from the side, bottom, or corner. This maintains a feeling that the virtual device is a single instrument, and not a plurality of individual windows of the type normally found on windows based computers. The sliding-tray audio controls (shown in FIG. 2) also contribute to this feeling. Similarly, when menus within a page change, such as the setup option page, the menus do not abruptly disappear: they shrink off to the right and new menus grow in their place.

The appearance of the unit can be changed with skins as described above, by toggling through the various skins to obtain the desired appearance. Skin designers, do not, however, have complete control over the appearance of the unit. They only have control over the hardware-like portions of the user interface. The unit always retains control of the display portion of the user interface. This arrangement insures that the unit can be easily used no matter what skin is selected, and insures that the commands are easily recognizable. The skins can, however, change the colors of the display area.

Another advantage of limiting skin flexibility is that it enables old skins to work with new revisions of the software. By limiting new revisions to the display area, changes to the hardware-type area can be avoided. As a result, skins that only modify the hardware-like interface will work properly with new revisions of the software.

The visual mode is integrated into the unit itself and is not implemented by opening another window on the windows-based computer. This provides a number of advantages: First, it enables the instrument to add text on top of the visual graphic display, which enables a large display to be used without taking up too much space on the computer screen. In addition, when the visual display window is incorporated within the unit itself, movement of the unit on the computer screen appears smooth. Conventional systems, on the other hand, typically paint the graphics in a separate window. This can lead to disjointed movement when the unit is dragged, because the display window may not follow the main unit in lockstep.

In addition, integrating the graphics into the unit facilitates the development of visual effects by third party developers. The software plug-ins developed by these developers does not need to obtain any knowledge of the text that is to appear over the images. The third party units render their graphics into a bit-map output and the unit modifies this bitmap output and paints the desired text on top of the background provided by the visual program. This approach also enables the unit to apply special effects to the video display, such as blurring and smoke, and does not require each developer of visual systems to provide their own special effects.

Preferably, the video content is correlated to the audio content in real time. But non-correlated systems may also be implemented. In addition, other non-audio outputs may also be added including, for example, a vibration output, a light show laser output, or a force-feedback output. These outputs are preferably correlated to the audio content in real time, but may be independent thereof.

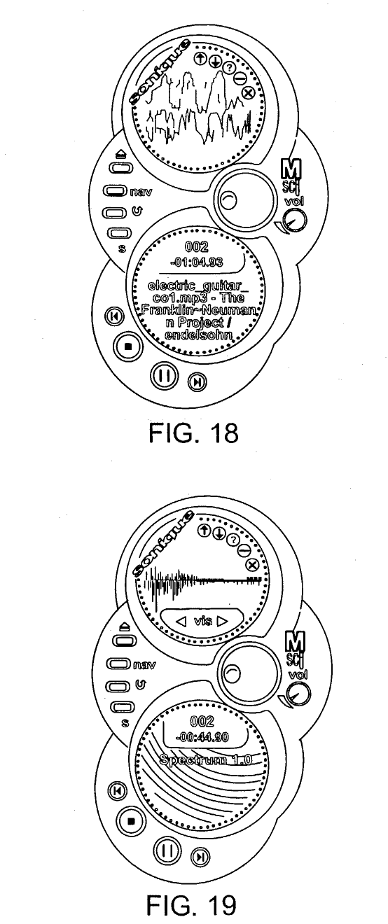

The second display size option is the medium size display, or mid-size mode. This display can be selected by clicking on the down arrow in the navigation buttons of the large display. The mid-state mode is shown in FIG. 18.

In this mode, most of the hardware-like controls are available in the form of buttons or knobs located on the boundary of the unit. The display area is split into two regions—an upper region and a lower region. Preferably, these regions are circularly shaped. The upper region is surrounded by a series of small indicator lights, which perform the same function as the play list indicators in the large mode. The lower region is surrounded by a second series of indicator lights, which correspond, to the track progress indicator of the large mode. Track selection can be accomplished by clicking on the playlist progress indicator, and time selection may be accomplished by clicking on the track progress indicator, in a manner similar to the large display mode.

Visual effects appear in the upper window, as do the navigation buttons. Although the equalizer settings and the amp and balance settings found in the audio enhancement control in the large mode are not present in this mode, the pitch control is provided as a rotary knob immediately left of the volume control. Operation of this rotary control is similar to the operation of the other rotary controls described above.

When the mouse pointer is placed in the lower portion of the upper display region, a menu pops up which allows the user to scroll through the various visualization displays. The user selects the desired visualization display by clicking on the right arrow or the left arrow. When the user clicks on one of these arrows, the name of the newly selected waveform appears on the lower display, as shown in FIG. 19. Otherwise, the name of the track currently being played will appear on the lower display, along with the track number, followed by the time indicator, which indicates the time within the track being played.

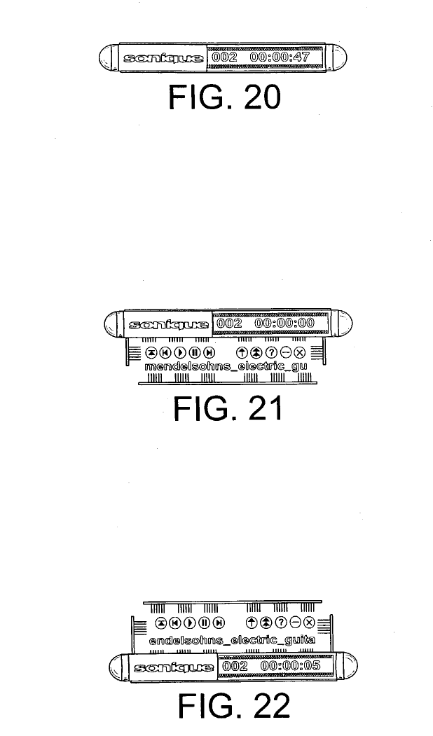

A third display mode is also available—the small-state mode. This can be selected by clicking on the down arrow navigator control from the mid-state mode or on the double down arrow navigator control from the large mode. In the small state mode, the unit appears as in FIG. 20. Here, the number on the left indicates the track, and the number on the right indicates the time within the track (or the time remaining in the track if the mouse button is clicked on the right hand field). The play list progress indicator is implemented in a tiny row of lights immediately above the track and time indicators. The track progress indicator is implemented in a tiny row of lights immediately below the track and time indicators.

When the mouse pointer is placed over the small-state display, a control tray pops out from the player, as shown in FIG. 21. This control tray contains the navigation controls found in the other two display modes. To return to the mid-size mode, the user clicks on the up button. To return to the large display mode, the user clicks on the double-up arrow button. In the small display mode, the hardware control buttons are located on this pop-out control tray, on the left side. The small state buttons on the left of the pop-out tray provide the play, stop, pause, track forward, track back, and file functions that correspond to the similar functions in the large-display mode.

Notably, the button tray slides out of the display as soon as the mouse pointer is placed over the display. No click of the mouse is required to pop the tray out.

The button-tray configuration shown in FIG. 21 appears whenever the unit is located in the top half of the computer screen. If, on the other hand, the unit is located on the bottom half of the display screen, the button tray will pop out of the top of the unit as shown in FIG. 22. The functionality of the buttons on the button tray is identical no matter if the tray pops out of the bottom or the top of the unit. If the small-size display is dragged from the lower half of the screen to the upper half of the screen, the button tray will flip to its appropriate position when the equator of the screen is crossed.

Normally, the bottom portion of the button tray contains an alphanumeric display which displays the name of the track currently being played. When the mouse pointer is placed over a button, the function of that button is temporarily displayed on this alphanumeric display. When the mouse pointer is placed over the play list progress indicator or track progress indicator, this alpha numeric display will display the name of the track corresponding to that position, or the time within the track, respectively. The user can jump to any desired track or any desired time within a track by clicking on the track progress indicator and/or the play list progress indicator in this mode as well.

The various display modes can be selected using the up/down arrows on the navigation buttons as described above. Alternatively, the user can toggle through the display mode by double clicking on an inactive area of one of the displays (corresponding to the chassis of the unit). When the user double clicks on the large display mode, the display will shift to the small display mode. When the user double clicks on the small display mode, the display will shift to the mid-size display mode. Finally, when the user double-clicks on an inactive area on a mid-size display unit, the large display unit will appear.

The up and down buttons are context sensitive. For example, when the skin setup mode is selected, the up and down arrow will toggle through the various available skins. When the visual mode is selected, the up and down buttons will toggle between the various available visual effects. Notably, the up and down buttons are always visible—they do not appear and disappear. In addition, their functionality is conserved between the various display modes. As a result, multiple sets of independent selectors for each perimeter are not needed, and the up and down buttons can be used for performing all selections.

In addition, the functions of the navigation control buttons, the play/stop button, the pause button, and the track forward and back buttons operation are conserved between modes.

By using the pop out button draw, the small-state modes uses a just-in-time philosophy, where the user is presented with options only when the user indicated that he wants to change an option. Unique features of this mode include the following: First, the draw pops out of the window, and is not a sub-window that pops out within a larger window. Second, the button draw will pop out of the small-state display even when the player is not the active window in a windows operating system computer. Third, the button tray includes control buttons—not a menu of text items. Fourth, the direction in which the tray pops depends on the position of the window on the screen. Fifth, the use of a pop-out button tray consumes less space than a text based pop down menu.

Optionally, advertisement or commercial output may be output in sync, or alternatively not in sync, with the audio content being played.

Optionally, in the audio control mode, the user can manipulate the equalization settings by clicking on the equalization curve itself displayed in the display window and dragging the curve.

Optionally, equalization presets can be used to compensate for the frequency response characteristics of output devices made by particular manufacturers. In this case, the hardware manufacturers would provide an equalization curve file. This file could then be selected by referencing the name of the manufacturers (e.g., by naming the file “Logitech USB speakers”).

When the file information object in the visual mode display is clicked, the unit dynamically generates an HTML output. Optionally, it may also link to a web site by referencing either a URL encoded in the audio source or by providing the title and artist of the song being played to a search engine, and capturing the output of the search engine. A graphic for the visual mode may also be downloaded from the Internet by referencing a search engine in a similar manner.

The methods of implementing virtual hardware devices (e.g., virtual buttons and volume controls) using a mouse as a pointing device are well known.

While the present invention has been explained in the context of the preferred embodiments described above, it is to be understood that various changes may be made to those embodiments, and various equivalents may be substituted, without departing from the spirit or scope of the invention, as will be apparent to persons skilled in the relevant art.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of implementing a user interface for a program running on a computer, the method comprising the steps of:
presenting a user interface to a user, the user interface having at least three different user-selectable operating modes, wherein a size of a displayed region presented to the user in each of the at least three operating modes is different; and
presenting a different set of controls for controlling the program to the user in each of the at least three operating modes.

2. The method of claim 1, wherein each of the at least three operating modes has a different shape.

3. The method of claim 1, wherein a first one of the at least three operating modes has a first size, a second one of the at least three operating modes has a size of about one third of the area of the first size, and a third one of the at least three operating modes has a size of about one thirtieth of the area of first size.

4. The method of claim 1, wherein the operating modes are selected by clicking on a change-size control region.

5. The method of claim 1, wherein the operating modes are selected by double-clicking on a background portion of a current operating mode.

6. The method of claim 1, wherein the program comprises a media player application program, and each of the at least three operating modes controls playback of the media.

7. The method of claim 6, wherein the media player program comprises an audio player.

8. A method of implementing a user interface for a program running on a computer, the method comprising the steps of:
presenting a first user interface to a user, the first user interface having a first size;
accepting a first command from the user, using the first user interface, to change the size of the user interface;
presenting a second user interface to the user in response to the first command, the second user interface having a second size different from the first size;
accepting a second command from the user, using the second user interface, to change the size of the user interface; and
presenting a third user interface to the user in response to the second command, the third user interface having a third size different from the first size and the second size.

9. The method of claim 8, further comprising the steps of:
accepting a third command from the user, using the third user interface, to change the size of the user interface;
presenting the first user interface to the user in response to the third command.

10. The method of claim 8, wherein the second size has an area that is about one third of the first size, and the third size has an area that is about one thirtieth of the first size.

11. The method of claim 8, wherein the first, second, and third user interfaces all have different shapes.

12. The method of claim 8, wherein the first command comprises a click on a change-size control region, and wherein the second command comprises a click on a change-size control region.

13. The method of claim 8, wherein the first command comprises a double-click on a background portion of the first user interface, and the second command comprises a double-click on a background portion of the second user interface.

14. The method of claim 8, wherein the program comprises a media player application program, and playback of the media is controlled by each of the first, second, and third user interfaces

15. The method of claim 14, wherein the media player application comprises an audio player.

16. A method of implementing a user interface for a program running on a computer, the method comprising the steps of:
providing a region on a display having a first control area and a second control area;
wherein the first control area includes a plurality of control regions that, when selected, control operation of the program, and
wherein the second control area displays information and control menus that depend on an operating mode of the program,
wherein a layout of the first control area is configurable in accordance with a user-selectable configuration file, and a layout of the second control area is independent of the user-selectable configuration file.

17. The method of claim 16, wherein the control regions in the first control area and the menus in the second control area are selected using a pointing device connected to the computer.

18. The method of claim 16, wherein a color scheme of the second control area is configurable in accordance with the user-selectable configuration file.

19. The method of claim 16, wherein the program comprises a media player application program.

20. The method of claim 19, wherein the media player application comprises an audio player.

21. A method of implementing a virtual instrument on a computer, the method comprising the steps of:
displaying a background region having an outer boundary;
displaying a plurality of control regions within the outer boundary, wherein actuation of the control regions control operation of the virtual instrument;
displaying a window region within the outer boundary; and
displaying status information about the virtual instrument and context-sensitive menus that control the instrument in the window region.

22. The method of claim 21, wherein the control regions and the context-sensitive menus are operated using a pointing device connected to the computer.

23. The method of claim 21, wherein a layout of the control regions on the background region is configurable in accordance with a user-selectable configuration file, and a layout of the status information and context-sensitive menus displayed in the window is independent of the user-selectable configuration file.

24. The method of claim 21, wherein the virtual instrument comprises a media player.

25. The method of claim 24, wherein the virtual instrument comprises an audio player.

26. A method of implementing a user interface for a program running on a computer, the method comprising the steps of:
displaying a first user interface region on a display, during a first time, the first user interface region having a first outer boundary and a first set of controls located within the first outer boundary that control operation of the program; and
modifying the user interface region on the display by adding, during a second interval of time, a supplemental region that is contiguous to the first user interface region and extends outside the first outer boundary, the supplemental region containing a second set of controls that control operation of the program.

27. The method of claim 26, wherein the first user interface region includes a boundary expansion control located within the first outer boundary of the user interface region, and actuation the boundary expansion control triggers the modifying step.

28. The method of claim 26, wherein the modifying step is triggered automatically in response to actuation of a predetermined operating mode of the program.

29. The method of claim 26, wherein more important functions of the program are controlled by the first set of controls, and less important functions of the program are controlled by the second set of controls.

30. The method of claim 26, wherein the user interface region includes a boundary contraction control, wherein actuating the boundary contraction control causes the supplemental region to disappear and causes the outer boundary of the user interface region to return to the first outer boundary.

31. The method of claim 26, wherein, when the boundary expansion control is actuated, the supplemental region extends out of the user interface region slowly, with a sliding action.

32. The method of claim 26, wherein the user interface region comprises controls for a media player, and the second set of controls comprises a plurality of frequency equalization controls.

33. The method of claim 26, wherein the user interface region comprises controls for an audio player, the first set of controls comprises play and stop controls, and the second set of controls comprises a multi-band audio frequency equalizer.

34. A method of implementing a user interface for a program running on a computer, the method comprising the steps of:
displaying, on a display, for a first interval of time, a user interface display in a first operating state in which the user interface display has a first outer boundary and a first set of controls located within the first outer boundary; and
displaying, on the display, for a second interval of time, the user interface display in a second operating state in which a portion of the user interface display extends outside the first outer boundary, with a second set of controls located on the user interface display outside the first boundary and the first set of controls located on the user interface display inside the first boundary,
wherein operation of the program in the first operating modes is controlled only by the first set of controls, and operation of the program in the second operating modes is controlled by the first set of controls and the second set of controls.

35. The method of claim 34, wherein the user interface display depicts a media player, and the second set of controls comprises a plurality of frequency equalization controls.

36. The method of claim 34, wherein the user interface display depicts an audio player, the first set of controls comprises play and stop controls, and the second set of controls comprises a multi-band audio frequency equalizer.

37. A method of implementing a user interface for a program running on a computer, the method comprising the steps of:
displaying, on a display, for a first interval of time, a main user interface region with a extension user interface region contiguous to the main user interface region, the extension user interface region including a set equalizer controls that are accessible during the first interval of time; and
displaying, on the display, for a second interval of time, the main user interface region without the extension user interface region, whereby the set of equalizer controls located on the supplemental control region is not accessible during the second interval of time.

38. The method of claim 37, further comprising the steps of:
displaying, on the display, a gradual transition of the extension user interface region moving from the displayed state to the non-displayed state, with a sliding motion; and
displaying, on the display, a gradual transition of the extension user interface region moving from the non-displayed state to the displayed state, with a sliding motion.

39. The method of claim 37, further comprising the step of displaying, on the display, a set of controls on the main user interface region that are accessible whether or not the extension user interface region is displayed.

40. The method of claim 37, wherein the user interface region comprises play and stop controls that are always accessible.

41. A user interface method for displaying progress of access to a plurality of items in a list, the method comprising the steps of:
providing an indicator that travels through a plurality of regions, each of the regions corresponding to a respective one of the items; and
moving the indicator, when an item in the list is accessed, into the region corresponding to the item being accessed.

42. A user interface method for displaying playback progress of a plurality of tracks in a media player, the method comprising the steps of:
providing a playlist indicator that travels through a plurality of regions, each of the regions corresponding to a respective one of the tracks; and
moving the playlist indicator, when playback of a track by the media player begins, into the region corresponding to the track being played.

43. A user interface method for displaying playback progress of a plurality of tracks in a media player, the method comprising the steps of:
providing a playlist indicator that travels through a plurality of regions, each of the regions corresponding to a respective one of the tracks; and
moving the playlist indicator, when a track is being played by the media player, through the region corresponding to the track being played.

44. The method of claim 43, further comprising the step of providing a track progress indicator, wherein the track progress indicator moves at a relatively constant speed from a start position to an end position as playback progresses from a beginning of a track to an end of a track, for each track.

45. The method of claim 43, wherein a size of all of the regions is substantially the same.

46. The method of claim 43, wherein the playlist indicator moves at a relatively constant speed from a beginning of each of the regions to an end of each of the regions as playback progresses from a beginning of the corresponding track to an end of the corresponding track.

47. The method of claim 46, wherein the playlist indicator is implemented using a bar graph.

48. The method of claim 46, wherein the playlist indicator is implemented using a plurality of individual display elements arranged in a straight line, and a display characteristic of the individual display elements is changed sequentially to indicate progress through the tracks.

49. The method of claim 46, wherein the playlist indicator is implemented using a plurality of individual display elements arranged along a curved path, and a display characteristic of the individual display elements is changed sequentially to indicate progress through the tracks.

50. The method of claim 43, wherein selecting a region of the playlist causes the media player to play the track corresponding to the selected region.

51. The method of claim 50, wherein the selecting of the region of the playlist is accomplished by clicking a button on a mouse.

52. The method of claim 43, wherein selecting a position within a selected region of the playlist causes the media player to play the track corresponding to the selected region, starting at a position within the track that is proportional to the selected position within the selected region.

53. The method of claim 52, wherein the selecting of the position within the region of the playlist is accomplished by clicking a button on a mouse.

54. A method of implementing a user interface for a multi-band controller, the method comprising the steps of:
displaying a plurality of controls, each set to an initial setting, wherein each of the controls controls a level for each of a plurality of bands, respectively;
accepting a user adjustment of a setting of one of the controls; and
adjusting, in response to the user adjustment, control settings that were not adjusted by the user.

55. The method of claim 54, wherein each of the bands is a band of audio frequencies.

56. The method of claim 54, wherein each of the controls comprises a slide control.

57. A method of implementing a user-interface for a multi-band frequency equalizer, the method comprising the steps of:
displaying a plurality of controls, wherein each of the controls controls an output level for each of a plurality of frequency bands, respectively;
displaying an initial level setting for each of the frequency bands;
accepting a user adjustment of a setting of one of the controls;
adjusting, in response to the user adjustment, controls that were not adjusted by the user; and
displaying an adjusted level setting for each of the frequency bands.

58. The method of claim 57, further comprising the step of storing an initial level setting for each of the frequency bands,
wherein, in the adjusting step, the setting of each control that was not adjusted by the user is adjusted by an amount inversely proportional to the square of the distance to the control that was adjusted, after the user adjustment of the setting has been finalized.

59. A method of implementing a user interface for a multi-band frequency equalizer in a media player, the method comprising the steps of:
(a) providing a media player;
(b) displaying a plurality of controls, each set to an initial setting, wherein each of the controls controls an output level for each of a plurality of audio frequency bands, respectively;
(c) accepting a user adjustment of a setting of one of the controls;
(d) adjusting, in response to the user adjustment, control settings that were not adjusted by the user; and
(e) adjusting frequency characteristics of playback by the media player in accordance with the setting of the control that was adjusted by the user and the control settings that were adjusted in step (d).

60. The method of claim 59, wherein each of the controls comprises a slide control.

61. The method of claim 59, wherein the indication that the setting adjustment of the control has been completed comprises releasing a button on a mouse.

62. The method of claim 59, further comprising the step of storing the initial setting for each of the controls, wherein step (d) comprises the steps of:
waiting for an indication that the user adjustment of the control has been completed; and
adjusting the settings for the controls that were not adjusted by the user to form a smooth curve that includes the adjusted setting of the user-adjusted control.

63. The method of claim 59, further comprising the step of storing the initial setting for each of the controls, wherein the step (d) comprises the steps of:
waiting for an indication that the user adjustment of the control has been completed; and
adjusting the settings for the controls that were not adjusted by the user by an amount that depends on the adjustment of the control that was user-adjusted and a proximity to the user-adjusted control.

64. The method of claim 59, wherein the indication that the setting adjustment of the control has been completed comprises releasing a button on a mouse.

65. A method of implementing a user interface control on a computer display, comprising the steps of:
(a) displaying a control region on the display with visual characteristics that distinguish the control region from a background;
(b) detecting when a user has selected the control region;
(c) momentarily increasing the brightness of the displayed control region in response to the detection made in step (b); and
(d) initiating a control function in response to the detection made in step (b).

66. The method of claim 65, wherein step (b) comprises the step of detecting when a user has used a mouse to click on the control region.

67. The method of claim 65, wherein the control region is circular.

68. A method of implementing a user interface for a media player with a computer-generated display, the method comprising the steps of:
(a) displaying a control region on the display with visual characteristics that distinguish the control region from a background;
(b) detecting when a user has selected the control region;
(c) momentarily increasing the brightness of the displayed control region in response to the detection made in step (b); and
(d) initiating a playback function of the media player in response to the detection made in step (b).

69. The method of claim 68, wherein step (b) comprises the step of detecting when a user has used a mouse to click on the control region.

70. The method of claim 68, wherein the control region is circular.

71. A method of implementing a dual-function user interface region on a computer display, comprising the steps of:
(a) displaying a control region at a given location on the display, the control region having a first color;
(b) detecting when a user has selected the control region while the control region has the first color;
(c) gradually fading out the first color of the control region in response to the detection made in step (b);
(d) gradually fading in a second color for the control region in response to the detection made in step (b); and
(e) initiating a first control function in response to the detection made in step (b).

72. The method of claim 71, wherein step (b) comprises the step of detecting when a user has used a mouse to click on the control region.

73. The method of claim 71, wherein the fade out and fade in occurs over a user-selectable period of time.

74. The method of claim 71, wherein the fade out and fade in occurs in accordance with a predetermined function.

75. The method of claim 71, wherein the fade out takes about 200 mSec in step (c) and the fade in takes about 200 mSec in step (d).

76. The method of claim 71, wherein the control region is circular.

77. The method of claim 71, further comprising the steps of
(f) detecting when a user has selected the control region while the control region has the second color;
(g) gradually fading out the second color of the control region in response to the detection made in step (f);
(h) gradually fading in the first color for the control region in response to the detection made in step (f); and
(i) initiating a second control function in response to the detection made in step (f).

78. The method of claim 77, wherein the first control function is a starting of playback in a media player, and the second control function is a stopping of playback in the media player.

79. The method of claim 78, wherein the first color is green, and the second color is red.

80. The method of claim 78, wherein the control region comprises a triangle icon while the control region has the first color, and the control region comprises a square icon while the control region has the second color.

81. A method of presenting information to a user on a computer-generated display, the method comprising the steps of:
introducing an image containing information into a display window so as to create an appearance that the introduced image is sliding into the display window; and
removing an image containing information from the display window so as to create an appearance that the removed image is sliding out of the display window.

82. A method of presenting menus to a user of a media player having a display window, the method comprising the steps of:
introducing an image containing a menu relating to operation of the media player into the display window so as to create an appearance that the introduced image is sliding into the display window; and
removing an image containing a menu relating to operation of the media player from the display window so as to create an appearance that the removed image is sliding out of the display window.

83. The method of claim 82, wherein the introduced image further contains status information.

84. The method of claim 82, wherein, in the introducing step, the introduced image slides into the display window from a side of the display window, and wherein, in the removing step, the removed image slides out of the display window to the side of the display window.

85. The method of claim 82, wherein, in the introducing step, the introduced image slides into the display window from a bottom of the display window, and wherein, in the removing step, the removed image slides out of the display window to the bottom of the display window.

86. The method of claim 82, wherein, in the introducing step, the introduced image slides into the display window from a corner of the display window, and wherein, in the removing step, the removed image slides out of the display window to the corner of the display window.

87. The method of claim 82, wherein a rate that the images slide into and out of the display window is user-selectable.

88. A method of providing visual effects for a media player running under a window-based operating system on a computer, the method comprising the steps of:
displaying, in a single window of the window-based operating system, a user interface region with a display window integrated into the user interface region; and
displaying, on the display window, visual effects corresponding to material being played on the media player.

89. The method of claim 88, further comprising the step of displaying text superimposed over the visual effects displayed on the display window.

90. The method of claim 88, wherein the visual effects displayed on the display window are generated based on bitmapped data.

91. The method of claim 88, wherein the window-based operating system is Linux or Microsoft® Windows.

92. A method of implementing a user interface for a program running on a computer, the method comprising the steps of:
(a) displaying, on a display, for a first interval of time, a main user interface region with a extension user interface region contiguous to the main user interface region, the extension user interface region including a set of control regions; and
(b) displaying, on the display, for a second interval of time, the main user interface region without the extension user interface region, whereby the set of control regions located on the extension user interface region are not accessible during the second interval of time.

93. The method of claim 92, further comprising the steps of:
displaying, on the display, during a third interval of time, a sliding transition of the extension user interface region from the displayed state to the non-displayed state; and
displaying, on the display, during a fourth interval of time, a sliding transition of the extension user interface region moving from the non-displayed state to the displayed state.

94. The method of claim 92, further comprising the step of displaying, on the display, a set of controls on the main user interface region that are accessible both when the extension user interface region is in the non-displayed state and when the extension user interface region is in the displayed state.

95. The method of claim 92, wherein step (a) is performed in response to a user positioning a pointer over the main user interface region, and step (b) is performed in response to a user positioning a pointer away from both the main user interface region and the extension user interface region.

96. The method of claim 95, wherein the user positions the pointer by moving a mouse.

97. The method of claim 96, wherein step (a) and step (b) are initiated without mouse clicks.

98. The method of claim 92, wherein the display is implemented on window-based operating system, the window containing the main user interface region is set to be always on top, and step (a) is performed in response to a user positioning a pointer over the main user interface region even when the main user interface region is not an active window, and step (b) is performed in response to a user positioning a pointer away from both the main user interface region and the extension user interface region even when the main user interface region is not the active window.

99. The method of claim 92, wherein the main user interface region comprises a user interface for a media player, and the control regions included on the extension user interface region implement functions of play and stop.

100. The method of claim 92 wherein the main user interface region comprises a user interface for a media player, and the control regions included on the extension user interface region implement functions of play, stop, pause, and change of track.

101. The method of claim 92, wherein a transition from the display presented in step (a) and the display presented in step (b) is made by sliding an image of the extension user interface region upwards when the main user interface region is located in the bottom half of the display, and sliding an image of the extension user interface region downwards when the main user interface region is located in the top half of the display.

102. The method of claim 101, wherein the extension user interface region flips from its upwards position to its downwards position when the main user interface region is dragged from the bottom half of the display to the top half of the display, and the extension user interface region flips from its downwards position to its upwards position when the main user interface region is dragged from the top half of the display to the bottom half of the display.
